(19) United States
(12) Patent Application Publication
(10) Pub. No.: US 2005/0029861 A1
(43) Pub. Date: Feb. 10, 2005

(54) Hydraulic modulator for an anti-lock device and the production method of the same

(76) Inventors: Robert Schnurr, Rielasingen-Worblingen (DE); Isao Inoue, Immenstadt (DE); Michael Schlitzkus, Dietmannsried (DE); Andreas Weh, Durach (DE); Masahiro Edamoto, Kanagawa (JP); Paul Hanson, Mt. Pleasant, SC (US); Douglas Patterson, Goose Creek, SC (US)

Correspondence Address: MALCOLM J ROMANO, 116 S CITRUS AVE, LOS ANGELES, CA, 90036, US

(21) Appl. No.: 10/495,820

(22) PCT Filed: Nov. 27, 2002
(86) PCT No.: PCT/DE02/04340

(30) Foreign Application Priority Data
Nov. 30, 2001 (DE) 10159054.7

(51) Int. Cl. B60T 8/36

(52) U.S. Cl. 303/119.2

(57) ABSTRACT

The invention relates to a housing block in an anti-lock hydraulic vehicle brake system, including a plurality of bores, conduits or holes intended for the function of the anti-lock arrangement.

The invention provides that of these function-specific bores, conduits or holes, at least one bore (8), one conduit, or one hole is provided with an engagement face (14) for the positive engagement of a clamping means (16) of a machine tool. As a result, the production of separate clamping bores can be dispensed with.

### PRIOR ART

The invention is based on a housing block in an anti-lock hydraulic vehicle brake system as generically defined by the preamble to claim 1, and to a method for producing it as generically defined by the preamble to claim 7.

From European Patent EP 0 699 571 A1 which defines this generic type, an anti-lock arrangement is known having a housing block such that for receiving an eccentric element, multi-position valves, two pump pistons, and first and second storage chambers, it has numerous recesses, bores, receiving holes, and the like. Moreover, additional bores and conduits are present in order to make hydraulic or electrical connections between the components, such as an electric motor, that are disposed in or on the housing block. A common feature of these bores, conduits, recesses and receiving holes is accordingly that they are intended solely for the function of the anti-lock arrangement. Moreover, the housing block has separate clamping bores on its top and bottom, which are intended for receiving clamping tools and are produced in a first machining step. Next, the housing block can be clamped for further machining steps, for instance in a machining center, by way of clamping tools introduced into the separate clamping bores. Between the function-specific bores, receiving holes and conduits on the one hand and the separate clamping bores on the other, however, a certain residual wall thickness must be present, making the housing block relatively large and heavy, which is disadvantageous, especially in view of the restricted space available in motor vehicle engine compartments and in view of the vehicle weight.

### ADVANTAGES OF THE INVENTION

Since according to the invention function-specific bores and conduits are simultaneously embodied as clamping bores for the sake of combining their function, production of separate clamping bores can be dispensed with, resulting in lower production costs. Without the presence of additional clamping bores, the housing block can furthermore be smaller and lighter in weight. Depending on the diameter of the particular clamping tools present, in principle every bore, receiving hole or conduit can be embodied as a clamping bore, especially since in housing blocks of anti-lock arrangements, bores, receiving holes and conduits of different sizes and diameters are as a rule present anyway.

In an especially preferred embodiment, the engagement face is formed by at least one annular bead, disposed on the radially inner circumference of the function-specific bore, which annular bead is embodied so that it can be engaged from behind by positive engagement by means of spreader means of a spreader mandrel introduced into the bore. The spreader means contain balls, which can be hydraulically forced preferably into a radially outer position and which are retained in an annular groove of a spreader head of the spreader mandrel. By means of the hydraulically actuated balls engaging the annular bead from behind, especially good positive engagement between the spreader mandrel and the housing block is possible, and consequently high chucking rigidity of the housing block can be attained, which has a positive effect on the precision of production.

The function-specific bore, supplemented with the clamping function, can be a blind bore or a through bore, depending on where the particular bore is located on the housing block. Bores as clamping bores that are located as much as possible in the vicinity of machining stations for subsequent machining steps are to be preferred, in order to avoid long lever arms between the chucking point and the machining force exerted at the machining point. Such long lever arms would be unwanted, because they cause shifting of the housing block, which unfavorably affects precision in production.

In a preferred refinement, the function-specific bore includes at least one through bore, which is intended as a leadthrough for an electrical contact and/or an electrical cord that creates an electrically conductive connection between an electric motor and an electronic control unit disposed on the opposite side of the housing block. This through bore, because of its diameter, is especially well suited for receiving spreader mandrels.

The method for producing the housing block of the invention is then characterized by the following steps:
a) making at least one function-specific bore in the housing block;
b) making an engagement face on or in the function-specific bore for the positive engagement of a clamping means of a machine tool;
c) clamping the housing block in the machine tool by positive engagement of the clamping means on the engagement face of the function-specific bore;
d) performing further production steps on the housing block in the position in which it is clamped to the function-specific bore.

### DRAWINGS

One exemplary embodiment of the invention is shown in the drawing and described in further detail in the ensuing description. In the drawings:

FIG. 1 is a perspective view of a preferred embodiment of the housing block of the invention;

FIG. 2 is a section taken along the line II-II of FIG. 1;

FIG. 3 shows a spreader mandrel, which positively engages a through bore of the housing block.

### DESCRIPTION OF THE EXEMPLARY EMBODIMENT

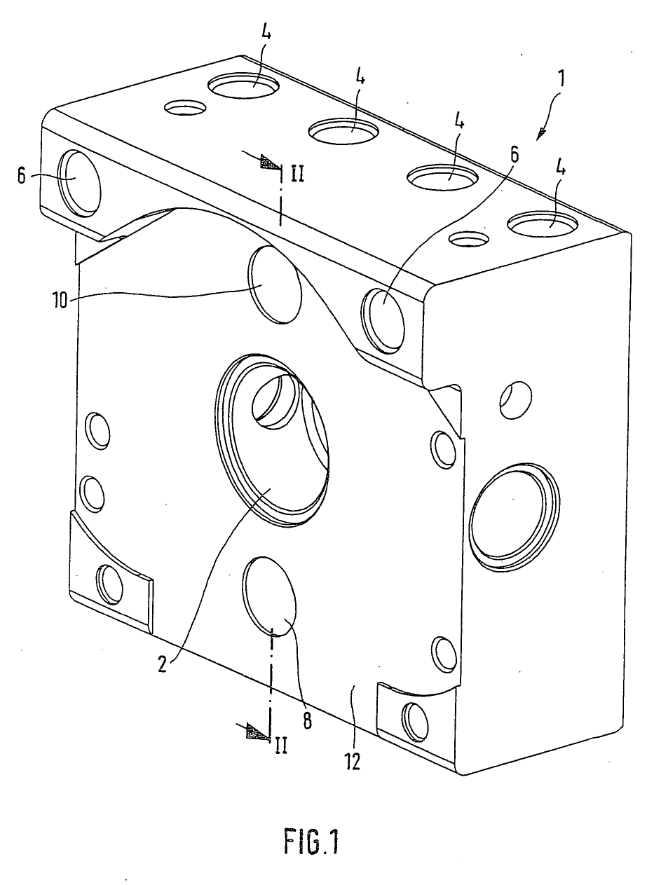

A preferred embodiment of a housing block 1 of the invention in an anti-lock hydraulic vehicle brake system is shown in perspective in FIG. 1.

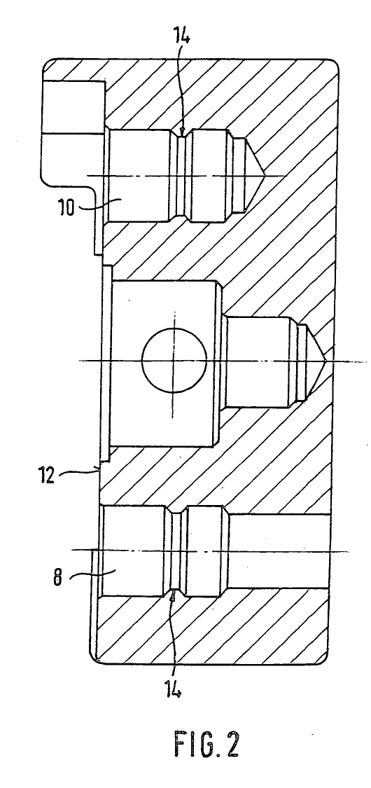

In addition to further conduits and bores, such as a stepped eccentric bore 2 for receiving an eccentric element driven by a motor shaft of an electric motor, not shown for reasons of scale, and bores 4 for wheel connections and bores 6 for master cylinder connections, the housing block 1 also includes a through bore 8, best seen in FIG. 2, which for instance is cylindrical and which is intended as a leadthrough for an electrical contact and/or an electrical cord. The electrical contact and/or the electrical cord creates an electrically conductive connection between the electric motor and an electronic control unit located on the opposite side of the housing block 1. Since as a result the through bore 8 has a function within the anti-lock arrangement, it is a function-specific through bore. A through bore intended for such a function is known for instance from International Patent Disclosure WO 01/26945 A1.

The through bore 8 is preferably parallel to and in the immediate vicinity of the eccentric bore 2. A center axis of a further bore, embodied preferably as a blind bore 10, which serves solely as a clamping bore, is located for instance in the same plane as the center axes of the eccentric bore 2 and of the through bore 8; relative to this through bore, the blind bore 10 is located on the far side of the eccentric bore 2.

According to the invention, the through bore 8 serves solely as a clamping bore for clamping means of one or more machine tools, with the aid of which the housing block 1 is machined, for instance for receiving clamping means of a machining center by positive engagement.

As seen particularly from FIG. 2, for this purpose both holes 8, 10 have engagement faces for the clamping means; the engagement faces are for instance embodied by encompassing annular beads 14, disposed on the radially inner circumference of the respective hole 8, 10, and spaced apart preferably equidistantly from the housing face 12 oriented toward the electric motor, and these annular beads are disposed perpendicular to the center axis of the respective bore 8, 10. The through bore 8 and the blind bore 10 are also manufactured in the form of stepped bores, and their diameter decreases in stepped form in a direction pointing away from the housing face 12. The two holes 8, 10 serve to receive spreader mandrels 16, which are secured for instance to a clamping device, not shown for reasons of scale, in the machining center.

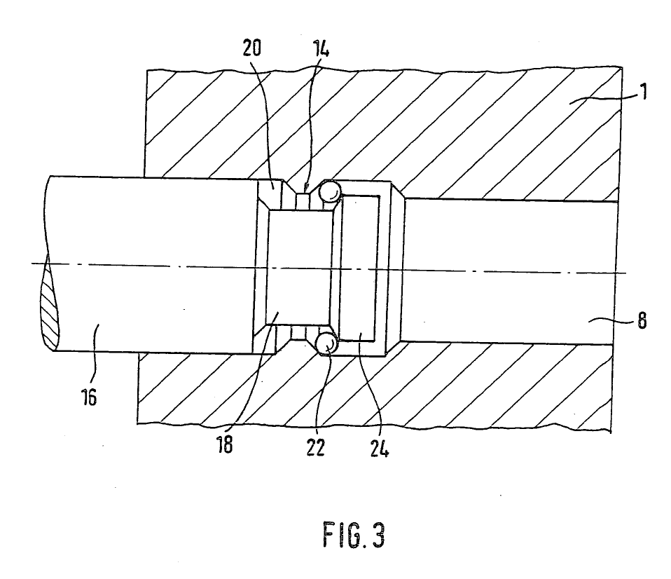

In FIG. 3, a spreader mandrel 16 introduced into the through bore 8 is shown. As shown, the spreader mandrel 16 has a spreader head 18 with spreader means which releasably engage the annular bead 14 from behind. The spreader means are preferably formed by balls 22, which are movably retained in an encompassing annular groove 20 of the spreader head 18 where they are distributed over the circumference, and which balls can be forced radially outward by the action of a hydraulic fluid that is under pressure into a position that engages the annular bead 14 of the through bore 8 from behind, as shown in FIG. 3. As a result, the spreader mandrel 16 is fixed by positive engagement in the through bore.

For removal of the spreader mandrel 16 from the through bore 8, the hydraulic pressure acting on the balls 22 is reduced, so that these balls can deflect radially inward and come to rest on the radially outer circumference of the annular groove 20, once they move past the annular bead 14. The radially inward-oriented motion of the balls 22 is facilitated by the beveled end faces of the annular bead 14. The end 24 of the spreader head 18 disposed on the far side of the annular groove 20 moreover has an outer diameter which is less than the inside diameter of the annular bead 14.

In the production of the housing block 1, the through bore 8 and the blind bore 10 are first made in a chuck, for instance by means of drilling, internal lathing, or circular milling. In a further step, the housing block 1 is clamped as described above by the two spreader mandrels 16, anchored by positive engagement in the holes 8, 10, and the further bores, conduits and receiving holes 2, 4, 6 are made.

In other embodiments, instead of only one function-specific bore 8, a plurality of such bores may be embodied as clamping bores.

1. A housing block in an anti-lock hydraulic vehicle brake system, including a plurality of bores, conduits or holes intended for the function of the anti-lock arrangement, characterized in that of these function-specific bores, conduits or holes, at least one bore (8), one conduit, or one hole is provided with an engagement face (14) for the positive engagement of a clamping means (16) of a machine tool.

2. The housing block of claim 1, characterized in that the engagement face is formed by at least one annular bead (14), disposed on the radially inner circumference of the function-specific bore (8), which annular bead is embodied so that it can be engaged from behind by positive engagement by means of spreader means (22) of a spreader mandrel (16) introduced into the bore (8).

3. The housing block of claim 2, characterized in that the spreader means contain balls (22), which can be hydraulically forced into a radially outer position and which are retained in an annular groove (20) of a spreader head (18) of the spreader mandrel (16).

4. The housing block of one of the foregoing claims, characterized in that the function-specific bore is a blind bore or a through bore (8).

5. The housing block of claim 4, characterized in that the function-specific bore includes at least one through bore (8), which is intended as a leadthrough for an electrical contact and/or an electrical cord that creates an electrically conductive connection between an electric motor and an electronic control unit disposed on the opposite side of the housing block (1).

6. The housing block of claim 5, characterized in that the through bore (8) is disposed adjacent to an eccentric bore (2) that is provided for receiving an eccentric element that is connected to a motor shaft of the electric motor.

7. A method for producing a housing block in an anti-lock hydraulic vehicle brake system, which block includes a plurality of bores intended for the anti-lock function, characterized by the following steps:
a) making at least one function-specific bore (8) in the housing block (1);
b) making an engagement face (14) on or in the function-specific bore (8) for the positive engagement of a clamping means (16) of a machine tool;
c) clamping the housing block (1) in the machine tool by positive engagement of the clamping means (16) with the engagement face (14) of the function-specific bore (8);
d) performing further production steps on the housing block (1) in the position in which it is clamped to the function-specific bore (8).
